(19) United States
(12) Patent Application Publication
(10) Pub. No.: US 2002/0086928 A1
(43) Pub. Date: Jul. 4, 2002

(54) Fire retardant polyamide composition and use thereof

(76) Inventor: Kunihiro Ouchi, Kuga-gun (JP)

Correspondence Address: BIRCH STEWART KOLASCH & BIRCH, PO BOX 747, FALLS CHURCH, VA, 22040-0747, US

(21) Appl. No.: 09/986,166

(22) Filed: Nov. 7, 2001

(30) Foreign Application Priority Data
Nov. 7, 2000 (JP) 2000-339015

(51) Int. Cl. C08K 3/10; C08K 3/22; C08K 5/02

(52) U.S. Cl. 524/409; 524/432; 524/469

(57) ABSTRACT

A fire retardant polyamide composition comprising:

20 to 85% by weight of a polyamide (A) of 280° C. or higher melting point, comprising repeating units constituted of:

dicarboxylic acid component units (i) consisting of 30 to 100 mol % of terephthalic acid component units, 0 to 70 mol % of component units of an aromatic dicarboxylic acid other than terephthalic acid and 0 to 70 mol % of component units of an aliphatic dicarboxylic acid having 4 to 20 carbon atoms, provided that the sum of these dicarboxylic acid component units is 100 mol %, and

diamine component units (ii) composed of aliphatic diamine component units and/or alicyclic diamine component units;

5 to 50% by weight of an inorganic reinforcement (B);

5 to 40% by weight of a brominated fire retardant additive (C) obtained by copolymerizing brominated polystyrene with an olefin having an epoxy group; and

0.1 to 10% by weight of an antimony compound and/or a zinc compound oxide (D), provided that the sum of components (A), (B), (C) and (D) is 100% by weight. This fire retardant polyamide composition is excellent in fire retardant properties, flowability, toughness and reflow heat resistance.

### FIELD OF THE INVENTION

The present invention relates to a fire retardant polyamide composition and an electrical or electronic part formed from the polyamide composition. More particularly, the present invention relates to a fire retardant polyamide composition which is excellent in reflow heat resistance and is suitable for use in manufacturing of an electrical or electronic part such as a thin (or thin-wall) connector of fine pitch, and relates to an electrical or electronic part formed from the polyamide composition, having an excellent reflow heat resistance.

Furthermore, the present invention relates to a fire retardant polyamide composition which is excellent in not only flowability, toughness and other mechanical properties but also reflow heat resistance, and relates to an electrical or electronic part, such as a connector, formed from the fire retardant polyamide composition. More particularly, the present invention relates to a fire retardant polyamide composition which is suitable for use in manufacturing of an electrical or electronic part such as an especially thin fine pitch connector of short connector terminal distance, and relates to an electrical or electronic part, such as a connector, having excellent heat resistance and formed from the fire retardant polyamide composition.

### BACKGROUND OF THE INVENTION

It is common practice to carry out soldering of connectors, etc. onto a printed board by the dipping method. In recent years, reflow (surface mount) soldering has been developed as a technique for carrying out a high-density mounting. The reflow soldering is a method comprising applying a creamy lead solder onto a printed wiring board by the use of printing technique, disposing a part such as a connector on the applied creamy solder, and heating the creamy lead solder by infrared radiation and/or hot air to thereby melt it so that the disposed connector or other part is surface mounted by the molten solder. When this reflow soldering method is employed, the surface mount part is exposed to high temperatures, for example, 230 to 240° C. by infrared radiation and/or hot air in a reflow oven. Therefore, materials from which surface mount connectors are formed must have high heat resistance.

Polyamides which can be melted and molded into desired configuration by heating are commonly used as materials for forming electronic parts. Generally, for example, nylon 6 and nylon 66 are widely used as polyamides. However, these aliphatic polyamides, although having desirable moldability, do not possess heat resistance that is satisfactory for a raw material used to manufacture surface mount parts exposed to high temperatures as aforementioned. In these circumstances, the demand for a polyamide of high heat resistance has increased, and nylon 46 has been developed. The nylon 46, although exhibiting a heat resistance higher than that of nylon 6 or nylon 66, has a drawback in that its water absorption coefficient is high. Therefore, the electrical or electronic part formed from a nylon 46 resin composition may suffer a dimensional change by water absorption, and the molding, upon absorbing water, has encountered such a problem that blister is caused by heating at the reflow. Apart from the nylon 46, an aromatic polyamide derived from an aromatic dicarboxylic acid such as terephthalic acid and an aliphatic alkylenediamine (see Japanese Patent Laid-open Publication No. 59(1984)-53536) has been developed. This aromatic polyamide is characterized in that not only is it excellent in heat resistance, mechanical properties and rigidity but also its water absorption coefficient is low as compared with those of aliphatic polyamides such as nylon 66 and nylon 46.

The polyamide resin, although inherently having self-extinguishing properties, must be loaded with a fire retardant additive in the use for manufacturing surface mount parts required to exhibit such a high level of fire retardation as V-0 specified in UL 94. Generally, loading a polyamide with a fire retardant additive such as a halide compound is known. For example, there are known compositions comprising a polyamide loaded with a halogenated polystyrene (see Japanese Patent Laid-open Publication No. 51(1976)-47034), for example, a composition containing brominated polystyrene obtained by brominating polystyrene, as represented by Pyrocheck 68PB produced by Ferro (see Japanese Patent Laid-open Publication No. 3(1991)-66755), a composition containing polybromostyrene obtained by polymerizing bromostyrene, which polybromostyrene is superior to brominated polystyrene in thermal stability (see Japanese Patent Laid-open Publication No. 5(1993)-320503 and WO 98/14510), and a composition comprising a polyamide loaded with a condensation product of bromophenol (see Japanese Patent Laid-open Publication No. 56(1981)-2100).

Lead/tin is conventionally used as a solder material. In recent years, a lead-free solder not containing poisonous lead has been developed and put to practical use with an attention to environment. Accordingly, the reflow temperature has increased to 250-260° C. from the 230-240° C. of lead solders. Therefore, a reflow heat resistance higher than before is now demanded for the resin used in surface mount parts such as a connector.

As apparent from the above, for use in surface mount parts such as a connector, the development of a fire retardant polyamide composition being excellent in fire retardant properties and toughness and having high flowability and reflow heat resistance is demanded.

### OBJECT OF THE INVENTION

It is an object of the present invention to provide a fire retardant polyamide composition being excellent in fire retardant properties and flowability and having high toughness and reflow heat resistance.

It is another object of the present invention to provide an electrical or electronic part being excellent in fire retardant properties and heat resistance, formed from the above fire retardant polyamide composition.

### SUMMARY OF THE INVENTION

In these circumstances, the inventor has made extensive and intensive investigations. As a result, it has been found that a polyamide composition comprising a specified aromatic polyamide and a specified brominated fire retardant additive is excellent in fire retardant properties and flowability and has high toughness and reflow heat resistance, and that the polyamide composition is suitable for use in an electrical or electronic part. The present invention has been completed on the basis of this finding.

Accordingly, the fire retardant polyamide composition of the present invention comprises:

20 to 85% by weight of a polyamide (A) of 280° C. or higher melting point, comprising repeating units constituted of:

dicarboxylic acid component units (i) consisting of 30 to 100 mol % of terephthalic acid component units, 0 to 70 mol % of component units of an aromatic dicarboxylic acid other than terephthalic acid and 0 to 70 mol % of component units of an aliphatic dicarboxylic acid having 4 to 20 carbon atoms, provided that the sum of these dicarboxylic acid component units is 100 mol %, and

diamine component units (ii) composed of aliphatic diamine component units and/or alicyclic diamine component units;

5 to 50% by weight of an inorganic reinforcement (B);

5 to 40% by weight of a brominated fire retardant additive (C) obtained by copolymerizing brominated polystyrene with an olefin having an epoxy group; and

0.1 to 10% by weight of an antimony compound and/or a zinc compound oxide (D), provided that the sum of components (A), (B), (C) and (D) is 100% by weight.

The fire retardant electrical or electronic part of the present invention comprises the above fire retardant polyamide composition of the present invention.

### BRIEF DESCRIPTION OF THE DRAWING

FIG. 1 shows the relationship between time and temperature exhibited in a reflow step of a reflow heat resistance test carried out in Examples and Comparative Example in the present invention.

### DETAILED DESCRIPTION OF THE INVENTION

The present invention will be described in detail below.

<Fire Retardant Polyamide Composition>

The fire retardant polyamide composition of the present invention comprises:

20 to 85% by weight of a polyamide (A) of 280° C. or higher melting point, comprising repeating units constituted of:

dicarboxylic acid component units (i) consisting of 30 to 100 mol % of terephthalic acid component units, 0 to 70 mol % of component units of an aromatic dicarboxylic acid other than terephthalic acid and 0 to 70 mol % of component units of an aliphatic dicarboxylic acid having 4 to 20 carbon atoms, provided that the sum of these dicarboxylic acid component units is 100 mol %, and

diamine component units (ii) composed of aliphatic diamine component units and/or alicyclic diamine component units;

5 to 50% by weight of an inorganic reinforcement (B);

5 to 40% by weight of a brominated fire retardant additive (C) obtained by copolymerizing bromostyrene with an olefin having an epoxy group; and

0.1 to 10% by weight of an antimony compound and/or a zinc compound oxide (D), provided that the sum of components (A), (B), (C) and (D) is 100% by weight.

Each of the components constituting the fire retardant polyamide composition of the present invention will be described below.

<Aromatic Polyamide (A)>

The polyamide (A) as a constituent of the fire retardant polyamide composition of the present invention is specifically an aromatic polyamide of 280° C. or higher melting point, comprising repeating units constituted of:

dicarboxylic acid component units (i) consisting of 30 to 100 mol % of terephthalic acid component units, 0 to 70 mol % of component units of an aromatic dicarboxylic acid other than terephthalic acid and 0 to 70 mol % of component units of an aliphatic dicarboxylic acid having 4 to 20 carbon atoms, provided that the sum of these dicarboxylic acid component units is 100 mol %, and

diamine component units (ii) composed of aliphatic diamine component units and/or alicyclic diamine component units.

As apparent from the above, the aromatic polyamide (A) for use in the present invention comprises repeating units derived from dicarboxylic acids (i) and diamines (ii).

The dicarboxylic acid (i) for forming the aromatic polyamide (A) for use in the present invention contains an aromatic dicarboxylic acid as an essential component. Preferably, terephthalic acid (i-a) is contained as the aromatic dicarboxylic acid.

This dicarboxylic acid (i) may contain an aromatic dicarboxylic acid other than terephthalic acid (i-b) and an aliphatic dicarboxylic acid (i-c).

The aromatic dicarboxylic acid other than terephthalic acid (i-b) can be, for example, isophthalic acid, 2-methylterephthalic acid, naphthalenedicarboxylic acid, or a mixture thereof.

The aliphatic dicarboxylic acid (i-c) can be, for example, an aliphatic dicarboxylic acid having an alkylene group having 4 to 20, preferably 6 to 12, carbon atoms. Examples thereof include succinic acid, adipic acid, azelaic acid, sebacic acid and mixtures thereof. Of these, adipic acid is preferred.

The dicarboxylic acid component units (i) as a constituent of the aromatic polyamide (A) for use in the present invention contain dicarboxylic acid component units derived from terephthalic acid (i-a) in an amount of 30 to 100 mol %, preferably 50 to 100 mol %. Further, the dicarboxylic acid component units (i) can contain component units derived from an aromatic dicarboxylic acid other than terephthalic acid (i-b) and/or an aliphatic dicarboxylic acid (i-c) having 4 to 20, preferably 6 to 12, carbon atoms in an amount of 0 to 70 mol %, preferably 0 to 50 mol %.

The diamine component units (ii) for forming the aromatic polyamide (A) in cooperation with the above dicarboxylic acid component units can be derived from a linear alkylenediamine having 4 to 20, preferably 6 to 12, carbon atoms and/or an alkylenediamine having a side chain alkyl group and having 4 to 20, preferably 6 to 12, carbon atoms and/or an alicyclic diamine.

Of these, as the alkylenediamine component units, component units from a linear alkylenediamine having 4 to 18, especially 6 to 12, carbon atoms and/or an alkylenediamine having a side chain alkyl group and having 4 to 18, especially 6 to 12, carbon atoms are preferred.

The linear alkylenediamine having 4 to 18 carbon atoms can be, for example, any of 1,4-diaminobutane, 1,6-diaminohexane, 1,7-diaminoheptane, 1,8-diaminooctane, 1,9-diaminononane, 1,10-diaminodecane, 1,11-diaminoundecane, 1,12-diaminododecane, 2-methyl-1,5-diaminopentane, 2-methyl-1,8-diaminooctane and mixtures thereof. Of these, 1,6-diaminohexane, 1,9-diaminononane and 1,10-diaminodecane are preferred. 1,6-Diaminohexane is especially preferred.

The alicyclic diamine can be, for example, cyclohexanediamine.

As the repeating unit constituted of a terephthalic acid component unit and an aliphatic diamine component unit, there can be mentioned, for example, the repeating unit of the formula:

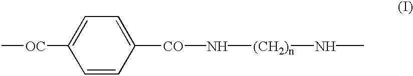

wherein n is 4 to 20, preferably 6 to 12.

As a suitable repeating unit capable of forming the polyamide for use in the present invention in cooperation with the repeating unit of the above formula (I), there can be mentioned, for example, the repeating unit of the formula:

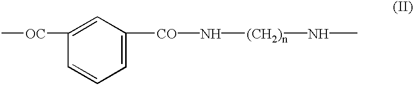

wherein n is 4 to 20, preferably 6 to 12, independently from the above formula (I).

Further, as a suitable repeating unit capable of forming the polyamide for use in the present invention in cooperation with the repeating unit of the above formula (I), there can be mentioned the repeating unit of the formula:

—OC—R¹—CO—NH—R²—NH— (III)

wherein each of R¹ and R² independently represents a bivalent hydrocarbon group having 4 to 20, preferably 6 to 12, carbon atoms or a cyclic group of any of the formulae:

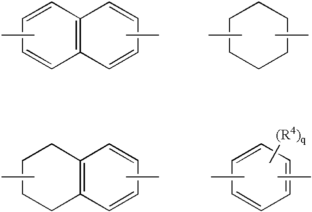

wherein R⁴ represents a hydrogen atom or an alkyl group having 1 to 5 carbon atoms, and q is an integer of 1 to 4. In the formula (III), although both R¹ and R² may be groups having the above cyclic structure, generally, the dicarboxylic acid component unit has a group having a cyclic structure, while the diamine component unit may have a bivalent hydrocarbon group having 4 to 20, preferably 6 to 12, carbon atoms. In this case, the bivalent hydrocarbon group having 4 to 20, preferably 6 to 12, carbon atoms may be a diamine of alicyclic structure such as cyclohexanediamine. Further, both the component units may have a bivalent hydrocarbon group having 4 to 18, preferably 6 to 12, carbon atoms. The hydrogen atoms bonded to the carbon atoms constituting the cyclic structure of the above bivalent group having a cyclic structure may at least partially be replaced by an alkyl group such as methyl or ethyl, another monovalent group, or a monovalent atom such as a halogen atom.

As apparent from the above, the aromatic polyamide (A) for use in the present invention has the above repeating units derived from dicarboxylic acids containing terephthalic acid and diamines. The content of terephthalic acid component units in the dicarboxylic acid component units as a constituent of the aromatic polyamide (A) is in the range of 30 to 100 mol %, preferably 50 to 100 mol %. The component units derived from an aromatic dicarboxylic acid other than terephthalic acid and/or an aliphatic dicarboxylic acid are contained in the dicarboxylic acid component units as a constituent of the aromatic polyamide (A) in a proportion of 0 to 70 mol %, preferably 0 to 50 mol %.

It is preferred that, provided that the component units derived from dicarboxylic acids amount to 100 mol %, the component units derived from terephthalic acid (a) be contained in an amount of 30 to 100 mol %, especially 40 to 80 mol %, and still especially 50 to 70 mol %; the component units derived from an aromatic dicarboxylic acid other than terephthalic acid (b) be contained in an amount of 0 to 50 mol %, especially 0 to 40 mol %, and still especially 0 to 20 mol %; and the component units derived from an aliphatic dicarboxylic acid (c) be contained in an amount of 0 to 70 mol %, especially 20 to 60 mol %, and still especially 30 to 50 mol %.

The thus obtained aromatic polyamide (A) has a high melting point. The melting point is generally 280° C. or higher. Among aromatic polyamides having such a melting point, aromatic polyamides of 290 to 340° C., preferably 300 to 330° C., melting point exhibit especially high heat resistance. The glass transition temperature of amorphous segments in the aromatic polyamide (A) is generally 80° C. or higher.

Further, the above aromatic polyamide exhibits a low value with respect to water absorption as well because it possesses the above specified structure.

The aromatic polyamide (A) for use in the present invention is excellent in heat resistance, and the processing temperature thereof at compounding or molding is generally in the range of 280 to 380° C., preferably 300 to 350° C.

A plurality of aromatic polyamides having different properties among the above aromatic polyamides can be used in combination in the fire retardant polyamide composition of the present invention. When use is made of a plurality of aromatic polyamides, the types of employed aromatic polyamides and the addition amount thereof can be regulated so that the entire properties of compounded aromatic polyamides fall within the above ranges.

In the fire retardant polyamide composition of the present invention, it is generally preferred that the above aromatic polyamide (A) be contained in an amount of 20 to 85% by weight, especially 25 to 70% by weight, based on the total weight of aromatic polyamide (A), inorganic reinforcement (B), brominated fire retardant additive (C) obtained by copolymerizing bromostyrene with an olefin having an epoxy group and antimony compound and/or zincous double oxide (D) which constitute the fire retardant polyamide composition of the present invention.

<Inorganic Reinforcement (B)>

The fire retardant polyamide composition of the present invention contains an inorganic reinforcement (B).

In the present invention, use can be made of various inorganic reinforcements having the morphology of, for example, fibers, powder, particles, plates, needles, cloths or mats.

Specifically, as the inorganic reinforcement, there can be mentioned inorganic fibers such as glass fiber, potassium titanate fiber, metal-clad glass fiber, ceramic fiber, wollastonite, carbon fiber, metal carbide fiber, metallic cured fiber, asbestos fiber and boron fiber. Of these fibrous fillers, glass fiber is especially preferred. The use of glass fiber enhances not only the moldability of polyamide composition but also the mechanical properties, such as tensile strength, flexural strength and flexural modulus, and heat resistance properties, such as heat distortion temperature, of molding from a thermoplastic resin composition. With respect to the above glass fiber, the average length is generally in the range of 0.1 to 20 mm, preferably 0.3 to 6 mm, and the aspect ratio is generally in the range of 10 to 2000, preferably 30 to 600. Using the glass fiber whose average length and aspect ratio are in the above ranges is preferred.

As the inorganic reinforcement other than the above fibrous inorganic reinforcement, namely as various inorganic reinforcements having the morphology of, for example, powder, particles, plates, needles, cloths or mats, there can be mentioned, for example, powdery or plate-shaped inorganic compounds such as silica, silica alumina, alumina, calcium carbonate, titanium dioxide, talc, wollastonite, diatom earth, clay, kaolin, spherical glass, mica, gypsum, red iron oxide, magnesium oxide and zinc oxide, and needle-shaped inorganic compounds such as potassium titanate.

These inorganic reinforcements may be used individually or in combination. These inorganic reinforcements can be treated with a silane coupling agent or a titanium coupling agent before use. For example, the inorganic reinforcements can be surface treated with a silane coupling agent, such as vinyltriethoxysilane, 2-aminopropyltriethoxysilane or 2-glycidoxypropyltriethoxysilane.

When these inorganic reinforcements are in particulate form, it is generally preferred that the average particle diameter thereof be in the range of 0.1 to 200 μm, especially 1 to 100 μm.

In the present invention, glass fiber is preferably employed among the above inorganic reinforcements.

In the fire retardant polyamide composition of the present invention, it is generally preferred that the above inorganic reinforcement (B) be contained in an amount of 5 to 50% by weight, especially 10 to 45% by weight, based on the total weight of aromatic polyamide (A), inorganic reinforcement (B), brominated fire retardant additive (C) obtained by copolymerizing bromostyrene with an olefin having an epoxy group and antimony compound and/or zinc compound oxide (D) which constitute the fire retardant polyamide composition of the present invention.

<Brominated Fire Retardant Additive (C) Obtained by Copolymerizing Bromostyrene with an Olefin Having an Epoxy Group>

The fire retardant polyamide composition of the present invention contains a brominated fire retardant additive (C) obtained by copolymerizing bromostyrene with an olefin having an epoxy group.

The olefin having an epoxy group can be, for example, any of glycidyl methacrylate, glycidyl ethacrylate, glycidyl itaconate and glycidyl citraconate. These may be used individually or in combination. Of these, glycidyl methacrylate is especially preferably employed.

In the copolymer with bromostyrene, the above olefin having an epoxy group is preferably contained in an amount of 0.01 to 20% by weight, still preferably 0.1 to 10% by weight.

In the fire retardant polyamide composition of the present invention, it is generally preferred that the above brominated fire retardant additive (C) obtained by copolymerizing bromostyrene with an olefin having an epoxy group be contained in an amount of 5 to 40% by weight, especially 10 to 35% by weight, based on the total weight of aromatic polyamide (A), inorganic reinforcement (B), brominated fire retardant additive (C) obtained by copolymerizing bromostyrene with an olefin having an epoxy group and antimony compound and/or zinc compound oxide (D) which constitute the fire retardant polyamide composition of the present invention

The brominated fire retardant additive (C) obtained by copolymerizing bromostyrene with an olefin having an epoxy group can be used in combination with brominated polystyrene and/or polybromostyrene (E).

The polybromostyrene may be one produced by polymerizing bromostyrene or brominated α-methylstyrene, or brominated polystyrene produced by brominating polystyrene or poly-α-methylstyrene.

Specifically, the polybromostyrene can be, for example, polydibromostyrene, polytribromostyrene, polypentabromostyrene or polytribromo-α-methylstyrene.

In particular, in the present invention, it is preferred to employ polybromostyrene produced by polymerizing bromostyrene or brominated α-methylstyrene obtained by carrying out bromination in the stage of a monomer. In the polybromostyrene obtained by first at least partially brominating the hydrogen atoms being constituents of the aromatic ring of styrene or α-methylstyrene as a starting monomer and thereafter polymerizing the brominated monomer, the bromine atoms replace hydrogen atoms bonded to the carbon atoms constituting the aromatic ring and are present in the polymer. The hydrogen atoms as constituents of the alkyl chain forming the main skeleton of the polymer are substantially not replaced by bromine atoms.

On the other hand, in the brominated polystyrene obtained by first producing polystyrene from styrene or α-methylstyrene as a starting monomer and thereafter brominating the polystyrene, although mainly the hydrogen atoms bonded to the carbon atoms constituting the aromatic ring are partially replaced by bromine atoms, the hydrogen atoms as constituents of the alkyl chain forming the main skeleton of the polymer are also partially replaced by bromine atoms. Accordingly, the polybromostyrene and the brominated polystyrene are different from each other in whether or not hydrogen atoms as constituents of the alkyl chain forming the main skeleton of the polymer are replaced by bromine atoms.

However, the polybromostyrene and the brominated polystyrene can generally be represented by the same formula:

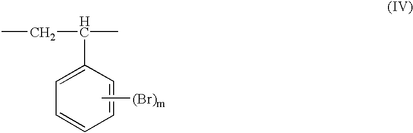

wherein m is an integer of 1 to 5.

Specifically, the brominated polystyrene is obtained by polymerizing styrene represented by the formula:

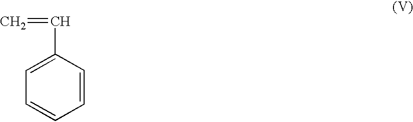

as a starting monomer and brominating the resultant polymer.

On the other hand, the polybromostyrene is obtained by polymerizing bromostyrene represented by the formula:

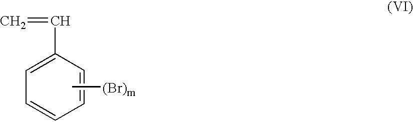

In the brominated polystyrene and/or polybromostyrene for use in the present invention, the bromine content is in the range of 44 to 68% by weight, preferably 60 to 68% by weight.

<Antimony Compound and/or Zinc Compound Oxide (D)>

The antimony compound used as component (D) in the present invention can be, for example, antimony trioxide, antimony pentoxide, antimony tetroxide or sodium antimonate.

The zinc compound oxide also used as component (D) can be, for example, any of zinc borates represented by the formulae:

2ZnO.3B₂O₃,

4ZnO.B₂O₃.H₂O, and

2ZnO.3B₂O₃.3.5H₂O,

zinc stannates represented by the formulae:

ZnSnO₃ and ZnSn(OH)₆, and

zinc calcium molybdate, basic zinc molybdate, highly efficient zinc molybdate/magnesium silicate compound and zinc phosphate.

These antimony compounds and zinc compound oxides can be used individually. Alternatively, a plurality of antimony compounds or a plurality of zinc compound oxides can be used in combination. Further, antimony compounds can be used in combination with zinc compound oxides.

Also, antimony compounds and zinc compound oxides can be used simultaneously. Of these, sodium antimonate, 2ZnO.3B₂O₃ and a combination thereof are preferably employed.

The use of the above component (D) in combination with the brominated fire retardant additive (C) obtained by copolymerizing bromostyrene with an olefin having an epoxy group realizes an enhancement of fire retardant properties.

In the fire retardant polyamide composition of the present invention, the above component (D) is generally used in an amount of 0.1 to 10% by weight, preferably 1 to 8% by weight, based on the total weight of aromatic polyamide (A), inorganic reinforcement (B), brominated fire retardant additive (C) obtained by copolymerizing bromostyrene with an olefin having an epoxy group and antimony compound and/or zinc compound oxide (D).

<Other Component>

The fire retardant polyamide composition of the present invention may be loaded with, in addition to the above components, other compounding agents such as a heat stabilizer, a weather stabilizer, a plasticizer, a thickener, an antistatic agent, a mold release agent, a pigment, a dye, an inorganic or organic filler, a nucleating agent, a fiber reinforcement and an inorganic compound (for example, carbon black, talc, clay or mica) in an amount not detrimental to the objectives of the present invention.

In particular, the loading of the fire retardant polyamide composition of the present invention with a fiber reinforcement among the above compounding agents realizes a further enhancement of heat resistance, fire retardant properties, rigidity, tensile strength, flexural strength and impact strength.

Furthermore, the fire retardant polyamide composition of the present invention may contain other polymers in an amount not detrimental to the objectives of the present invention. Examples of such other polymers include polyolefins such as polyethylene, polypropylene, poly-4-methyl-1-pentene, ethylene/1-butene copolymer, propylene/ethylene copolymer, propylene/1-butene copolymer and polyolefin elastomer, and further include polystyrene, polyamides, polycarbonates, polyacetals, polysulfones, polyphenylene oxide, fluororesins and silicone resins.

Still further, the fire retardant polyamide composition of the present invention may contain the above brominated fire retardant additive (C) obtained by copolymerizing bromostyrene with an olefin having an epoxy group, the above brominated polystyrene and/or a brominated fire retardant additive other than the polybromostyrene. This brominated fire retardant additive can be, for example, any of the brominated compounds including:

hexabromobenzene, pentabromoethylbenzene, hexabromobiphenyl, decabromodiphenyl, hexabromodiphenyl oxide, octabromodiphenyl oxide and decabromodiphenyl oxide;

tetrabromobisphenol A, and tetrabromobisphenol A derivatives such as tetrabromobisphenolAbis (hydroxyethyl ether), tetrabromobisphenolAbis (2, 3-dibromopropyl ether), tetrabromobisphenol A bis(bromoethyl ether) and tetrabromobisphenol A bis(allyl ether),

tetrabromobisphenol S, and tetrabromobisphenol S derivatives such as tetrabromobisphenol S bis (hydroxyethyl ether) and tetrabromobisphenol S bis(2,3-dibromopropyl ether),

tetrabromophthalic anhydride, and tetrabromophthalic anhydride derivatives such as tetrabromophthalimide and ethylenebistetrabromophthalimide,

ethylenebis(5,6-dibromonorbornane-2,3-dicarboxyimi de),

tris(2,3-dibromopropyl-1) isocyanurate,

Diels-Alder adduct of hexabromocyclopentadiene,

tribromophenyl glycidyl ether,

tribromophenyl acrylate,

ethylene bistribromophenyl ether,

ethylenebispentabromophenyl,

ethylene bispentabromophenyl ether,

tetradecabromodiphenoxybenzene,

bromopolyphenylene oxide,

bromoepoxy resin,

bromopolycarbonate,

polypentabromobenzyl acrylate,

octabromonaphthalene,

pentabromocyclohexane,

hexabromocyclododecane,

bis(tribromophenyl)fumaramide, and

N-methylhexabromodiphenylamine.

<Composition>

The fire retardant polyamide composition of the present invention comprises the above component (A), component (B), component (C) and component (D), and further comprises other components according to necessity.

With respect to the fire retardant polyamide composition of the present invention, it is preferred that the fire retardant properties evaluated on standard UL 94 be V-0 equivalent.

The evaluation of fire retardant properties on standard UL 94 is carried out as follows.

An upper end of a specimen is clamped so as to set the specimen upright in a testing device. A lower end of the specimen is exposed to given flame for 10 sec, and the flame is removed. With respect to the specimen, the first combustion time is measured.

Upon the termination (extinguishment) of combustion in the first combustion test of the specimen, the lower end is immediately exposed to flame for 10 sec, and the flame is removed. The second combustion time is measured.

Ten data are taken, among which the maximum is designated as M and the total is designated as T. With respect to the test result, the fire retardant properties are evaluated on the following criteria:

V-0 equivalent: M is not greater than 10 sec, and T is not greater than 50 sec. The specimen is not inflamed to the clamped portion, and it does not occur that a molten specimen drops to thereby ignite underlying cotton.

V-1 equivalent: M is not greater than 30 sec, and T is not greater than 250 sec. The specimen is not inflamed to the clamped portion, and it does not occur that a molten specimen drops to thereby ignite underlying cotton.

V-2 equivalent: M is not greater than 30 sec, and T is not greater than 250 sec. The specimen is not inflamed to the clamped portion, but a molten specimen drops to thereby ignite underlying cotton.

In the present invention, when the components (C) and (D) are mainly used as the fire retardant additive, the fire retardant additive forms fine particles in the aromatic polyamide and is very uniformly dispersed therein. Therefore, the fire retardant polyamide composition of the present invention not only has excellent fire retardant properties but also is excellent in thin (thin-wall) flow properties and hence in moldability. Accordingly, the fire retardant polyamide composition of the present invention is suitable for use as a fire retardant resin for forming a fine electrical or electronic part, in particular, an electrical or electronic part having such a structure that fine terminals are inserted, such as a connector.

Moreover, not only does the fire retardant polyamide composition of the present invention have excellent moldability, as mentioned above, but also the molding therefrom exhibits low water absorption and is excellent in mechanical properties such as toughness. Therefore, it finds appropriate application in an electrical or electronic part.

The fire retardant polyamide composition of the present invention can be produced by mixing the above components by means of, for example, a Henschel mixer, a V blender, a ribbon blender or a tumbler blender, or produced by effecting such mixing, subsequently melt kneading the mixture by means of, for example, a single screw extruder, a multi-screw extruder, a kneader or a Banbury mixer, and thereafter effecting granulation or pulverization.

<Fire Retardant Electrical or Electronic Part>

The electrical or electronic part of the present invention can be produced by heating the thus obtained fire retardant polyamide composition of the present invention to thereby melt it, molding the melt into desired configuration and cooling the same. The molding can be accomplished by, for example, shaping the molten fire retardant polyamide composition of the present invention with the use of a metal mold capable of forming a desired configuration.

The fire retardant polyamide composition of the present invention is excellent in a melt flowability exhibited in a thin (thin-wall) flow length test, and an electronic part such as a connector having a multiplicity of thin portions can be efficiently produced therefrom.

Moreover, the electronic part such as a connector produced from the fire retardant polyamide composition of the present invention has such a high toughness that the probability of cracking at connector joining (for example, insertion of male connector terminal in female connector) is low. Further, the electrical or electronic part of the present invention has such a high heat resistance that, in a reflow soldering step, the probability of thermal deformation or blistering is low.

In summing up, the fire retardant electrical or electronic part of the present invention is excellent in fire retardant properties and heat resistance, exhibits low water absorption and is excellent in mechanical properties such as toughness.

### EFFECT OF THE INVENTION

In the present invention, there can be provided the fire retardant polyamide composition which is excellent in not only fire retardant properties but also mechanical properties such as toughness and which is excellent in flowability, being suitable for use in an electrical or electronic part. Further, in the present invention, there can be provided the electrical or electronic part formed from the above fire retardant polyamide composition, being excellent in not only fire retardant properties and heat resistance but also mechanical properties.

### EXAMPLE

The present invention will further be illustrated below with reference to the following Examples which in no way limit the scope of the invention.

In the following Examples and Comparative Example, the properties were measured and evaluated in the following manner.

<Melting Point>

A DSC endothermic curve of polyamide was obtained, and the temperature at maximum peak position was designated as melting point (Tm). The endothermic curve was obtained by packing an aluminum pan with a specimen and heating the specimen at a rate of 10° C./min.

<Flexural Test (Toughness)>

A specimen of 64 mm length, 6 mm width and 0.8 mm thickness was prepared by the use of an injection molding machine. A flexural test of the specimen was performed at a span of 26 mm and at a flexural rate of 5 mm/min. The flexural strength, flexural modulus, energy required for fracturing the specimen (toughness) and strain at fracture were measured.

Molding machine: Tuparl TR40S3A, manufactured by Sodick Plustech Co., Ltd.,

Cylinder temperature: NT/C1/C2/C3=320° C./320° C./310° C./300° C.,

Metal mold temperature: 120° C., and

Flexural tester: AB5 manufactured by NTESCO.

<Flow Length Test>

Injection into a bar flow metal mold of 10 mm width and 0.5 mm thickness was carried out with the use of the following machine under the following conditions. The first 20 shots were disposed of, and the flow lengths (mm) of subsequent 10 shots were measured. An average length was calculated.

Injection molding machine: IS-55EPN, manufactured by Toshiba Machine Co., Ltd.,

Injection pressure: 1000 kg/cm²,

Injection rate: 99%,

Cylinder temperature: NT/C1/C2/C3=320° C./320° C./310° C./300° C., and

Metal mold temperature: 120° C.

<Reflow Heat Resistance Test>

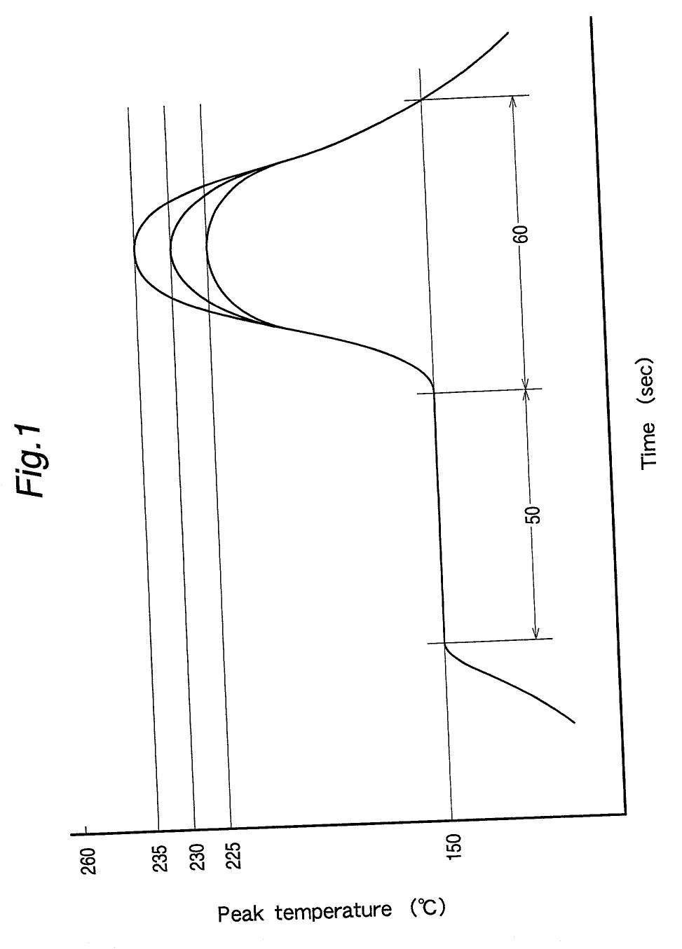

A specimen of 64 mm length, 6 mm width and 0.8 mm thickness was prepared by injection molding, and conditioned in relative humidity of 95% at 40° C. for 96 hr. A reflow step of FIG. 1 was effected with the use of reflow soldering device using both infrared radiation and hot air (SOLSIS-2011R manufactured by Nippon Antom Industry Co., Ltd.).

The specimen was placed on a 1 mm thick glass reinforced epoxy board. Further, a temperature sensor was mounted on the board, and a profile measurement was carried out. Referring to FIG. 1, the specimen was heated to given set temperature, and the maximum of peak temperatures at which the specimen was not melted and at which void did not occur at the surface thereof was measured. The maximum of set temperature was designated as reflow resistance temperature.

<Fire Retardant Properties>

The fire retardant properties were evaluated on standard UL 94.

### Example 1

The following components (A) to (D) were mixed together in amounts specified in Table 1, and, per 100 parts by weight of the sum of components (A) to (D), loaded with 1 part by weight of maleic SEBS (Tuftec M1913 produced by Asahi Chemical Industry Co., Ltd.) as a drip preventive at combustion, 0.3 part by weight of hydrotalcite (DHT-4C produced by Kyowa Chemical Industry Co., Ltd.) as a halogen catcher, 0.3 part by weight of wax (Hostamont NaViOl produced by Clariant Japan K.K.) as a mold release agent and 0.7 part by weight of talc (Hi-filler #100 clay 95, produced by Matsumura Sangyo Co., Ltd.) as a crystal nucleating agent. The mixture was charged in a twin-screw vented extruder set for 310° C., melt kneaded and pelletized. Thus, pellets of polyamide resin composition were obtained.

(A) aromatic polyamide

components:

dicarboxylic acid component=55 mol % of terephthalic acid and 45 mol % of adipic acid, and

diamine component=100 mol % of 1,6-diaminohexane

intrinsic viscosity (η): 1.0 dl/g, and

melting point: 310° C.;

(B) inorganic reinforcement

glass fiber (CS03JAFT2A produced by Asahi Fiber Glass);

(C) brominated fire retardant additive obtained by copolymerizing bromostyrene with an olefin having an epoxy group

bromostyrene/glycidyl methacrylate copolymer CN-2044B (bromine content: 65%) produced by GLC; and

(D) antimony compound and/or zincous double oxide sodium antimonate (NaSbO₃).

The properties of obtained polyamide resin composition were evaluated. The results are listed in Table 1.

### Comparative Example 1

A polyamide resin composition was produced in the same manner as in Example 1 except that brominated polystyrene and polybromostyrene were used in place of the above component (C). The properties of obtained polyamide resin composition were evaluated. The results are listed in Table 1.

Particulars of the brominated polystyrene and polybromostyrene were as follows:

brominated polystyrene: PRF-1200ZEX (bromine content 68%) produced by Manac Incorporated, and

polybromostyrene: PDBS-80 (bromine content 60%) produced by GLC.

### Examples 2 and 3

Polyamide resin compositions were produced in the same manner as in Example 1 except that use was made of brominated polystyrene and polybromostyrene together with the component (C). The properties of obtained polyamide resin compositions were evaluated. The results are listed in Table 1.

TABLE 1

| | | | Comp.Ex. | | |
|---|---|---|---|---|---|
| | | Example 1 | 1 | Example 2 | Example 3 |
| component (A) (wt. %) | | 42 | 42 | 42 | 42 |
| component (B) (wt. %) | | 30 | 30 | 30 | 30 |
| component (C) (wt. %) | | 24 | 0 | 5 | 12 |
| component (D) (wt. %) | | 4 | 4 | 4 | 4 |
| brominated polystyrene | | 0 | 7 | 5 | 4 |
| polybromostyrene | | 0 | 17 | 14 | 8 |
| properties | flexural | 229 | 223 | 242 | 234 |
| | strength | | | | |
| | (MPa) | | | | |
| | flexural | 12800 | 12100 | 12600 | 13000 |
| | modulus | | | | |
| | (MPa) | | | | |
| | fracture | 35 | 35 | 36 | 36 |
| | energy | | | | |
| | (mJ) | | | | |
| | strain (mm) | 3.0 | 3.1 | 3.1 | 3.0 |
| | thin flow | 64 | 68 | 67 | 67 |
| | length | | | | |
| | (mm) | | | | |
| | water | 1.9 | 1.9 | 1.9 | 1.9 |
| | absorption | | | | |
| | (%) | | | | |
| | reflow | 235 | 225 | 225 | 230 |
| | resistance | | | | |
| | temp. (° C.) | | | | |
| | fire | V-0 | V-0 | V-0 | V-0 |
| | retardant | | | | |
| | properties | | | | |

what is claimed is:

1. A fire retardant polyamide composition comprising:
20 to 85% by weight of a polyamide (A) of 280° C. or higher melting point, comprising repeating units constituted of:
dicarboxylic acid component units (i) consisting of 30 to 100 mol % of terephthalic acid component units, 0 to 70 mol % of component units of an aromatic dicarboxylic acid other than terephthalic acid and 0 to 70 mol % of component units of an aliphatic dicarboxylic acid having 4 to 20 carbon atoms, provided that the sum of these dicarboxylic acid component units is 100 mol %, and
diamine component units (ii) composed of aliphatic diamine component units and/or alicyclic diamine component units;
5 to 50% by weight of an inorganic reinforcement (B);
5 to 40% by weight of a brominated fire retardant additive (C) obtained by copolymerizing brominated polystyrene with an olefin having an epoxy group; and
0.1 to 10% by weight of an antimony compound and/or a zinc compound oxide (D), provided that the sum of components (A), (B), (C) and (D) is 100% by weight.

2. The fire retardant polyamide composition as claimed in claim 1, which further comprises brominated polystyrene and/or polybromostyrene.

3. A fire retardant electrical or electronic part comprising the fire retardant polyamide composition as claimed in claim 1 or 2.
